(19) United States
(12) Patent Application Publication
(10) Pub. No.: US 2018/0271328 A1
(43) Pub. Date: Sep. 27, 2018

(54) COMPACT POCKET-SIZED AND FUNNELED HERB OR TOBACCO GRINDER

(71) Applicant: Shant PETROSSIAN, Burbank, CA (US)

(72) Inventor: Shant PETROSSIAN, Burbank, CA (US)

(21) Appl. No.: 15/936,276

(22) Filed: Mar. 26, 2018

Related U.S. Application Data
(60) Provisional application No. 62/475,874, filed on Mar. 24, 2017.

(51) Int. Cl. A47J 42/34; A47J 42/38

(52) U.S. Cl. CPC A47J 42/34; A47J 42/38

(57) ABSTRACT

The present invention discloses an herbal grinder having inner teeth in a grinding chamber, peripheral walls attached to a grinding top and bottom, a top funnel to house unrefined material, and a fine particulate chamber at the bottom for capture and storage.

### CROSS-REFERENCE TO RELATED APPLICATIONS

The owner of record claims the benefit of prior provisional appl. No. 62/475,874 filed on Mar. 24, 2017.

### BACKGROUND OF THE INVENTION

### 1. Field of Invention

The present invention relates to grinders for tobacco, herbs, or other similar material into finer particulate with enhanced functionality and design over conventional grinders. See grinders in Class 241 for solid material comminution or disintegration. The present invention is designed to improve upon traditional herb/tobacco grinders by: combining key grinding processes; enhanced usability; greater portability; avoiding spillage during transport with grounding material and/or refined particulate ground matter; and providing simultaneous pre-grinding and post-grinding capability in a single device—which is lacking in conventional herb/tobacco grinders.

### 2. Description of the Related Art

Grinders to convert unrefined tobacco or herbs into ground material are known in the related art. Conventional grinders typically conform to a general shape and dimensional ratio, namely, a cylinder with wide diameter and short height, and usually involve two or four pieces. The first two pieces are generally the primary mechanisms—a grinding top and grinding bottom; and additional pieces include mesh screens which are used to separate finer particulate from the main ground matter. Grinders which include mesh screens typically include an additional chamber to collect the fine particulate after it is separated. For example, U.S. Pub. No. 20130015278 and U.S. Pat. No. 795,746. Also known are grinders which include a funnel—wider at the top and narrower at the bottom—where the conventional funnel is at the bottom of the grinder to empty out ground matter.

Conventional grinders create several problems for the user. Their shape makes them awkward to carry in small spaces like pockets. When closed and not in use or when opened to be emptied, their wide openings make spills and messes an inevitability. They require a separate surface for pouring out, collecting, and preparing the ground material and, furthermore, can be cumbersome even with the use of both hands. See FIG. 2 (PRIOR ART). Even in the case of the few grinders which include a funnel, said funnels are located at the bottom; there is only one direction for all ground material to exit. Thus, conventionally, the ground material cannot be separated into its less fine and finer parts FIG. 3 (PRIOR ART). The present invention improves upon conventional grinders.

Conventional grinders with bottom funnels are known. Such funnels taper to a smaller diameter at the bottom, which is the opposite of the present invention. Such conventional grinders place the funnel at the bottom of the grinder which hinders another design aspect. Some grinders on the market include a meshed capture chamber at the bottom where smaller particulate can be separated and saved for later use. Those grinders which include the funnel placed at the bottom remove the possibility of placing a meshed capture chamber at the bottom; the capture chamber and greater material exit area or spout are through the bottom in such conventional bottom-funneled grinders.

Based on the limitations in the related art, it can be seen there is a need for improved size and dimensions. It can also be seen that there is a need for reusability, portability, pre- and post-grinding storage capabilities, as well as enhanced quality of ground material. It can also be seen that there is a need for a grinder that provides an intuitive top and bottom orientation. Finally, it can be seen that there is a need to avoid an awkward funnel at the bottom which prevents standing a grinder on its own.

### SUMMARY OF THE PRESENT INVENTION

The present invention seeks to resolve the shortcomings of typical grinders as explained in the prior background section. This will be accomplished with the change and addition of certain features.

An aspect of the present invention is ratio inversion compared to conventional grinders in the related art. For example, the present invention improves on the shape of traditional grinders with a greater width and shorter height by switching the width-to-height ratio, producing a relatively taller and narrower cylinder (FIG. 1 —PRIOR ART). The present invention's configuration required redesign of the typical grinding teeth and required design additions to allow the grinding teeth therein to function without colliding via walls as described in this disclosure.

Another aspect of the present invention it to provide a more suitably portable shape to be carried in the pocket or in other small portable locations, such as pouches, purses, backpacks, and bags.

An additional aspect of the present invention is effective grinding. Longer grinding teeth compared to conventional grinders can allow the present invention to perform superior grinding functions over longer tooth surface areas within the grinding chamber. By way of non-limiting illustration, the present invention allows the entire height of the teeth to be used for grinding, thus increasing the grinding surface over the smaller diameter of the entire grinder. Longer grinding teeth subsequently require another design addition. If the top and bottom teeth were to be allowed to be freely separated from each other (pulled apart) and put back together without any guide to avoid collisions with the teeth, such collisions between the teeth may damage them, but this is addressed by providing walls to contain the teeth. Walls enhance the overall integrity of the grinder. Therefore, a further aspect of the present invention is to facilitate safety while addressing the need to protect the longer teeth simultaneously. For example, conventional grinders sometimes suffer from broken pieces of the teeth, whether manufactured in metal or plastic, and such conventional grinders may be harmful to the user if ground with tobacco or other edibles and smoked or otherwise ingested. To address safety concerns, the present invention provides a grinding top and bottom which can be permanently fixed with equally tall side walls which can guide the two sides together, thereby preventing mashing or harming the grinding teeth.

Another aspect of the present invention is to permit carrying of pre-ground material. The present invention has a smaller upper diameter which allows for the addition of a funnel with cap at the top of the grinder, which is not known in the related art.

Thus, an aspect of the present invention is to avoid needing to be frequently or repeatedly opened to the emptied, nor does the present invention require a surface for emptying or cleaning between each use. The present invention provides a funneled top to facilitate the foregoing aspects. An aspect of the present invention is to the capture chamber particles at the bottom, while keeping the spout or funnel at the top, thus permitting multiple benefits over the related art.

Another aspect of the present invention is one-handed use, particularly when emptying the ground material. Since typical grinders must be completely opened to empty the material inside, this hinders the process of next use and requires re-loading the initial chamber. The present invention, with a capped funnel at the top, allows the user to empty the material with one hand into another container (e.g. pipe, rolling paper for cigarettes, etc.) which may be held in the other hand or resting on a surface.

Given the present invention's longer length and shorter width, special attention has been given to the type of grinding teeth that can fit in the allotted area, their design and manufacture, and their method of operation. As opposed to typical grinders' very small and short teeth spread over a wide area, this grinder has long teeth spread over a narrower area. In contrast, the teeth of the present invention are generally longer. Furthermore, an aspect of the present invention is to meet or exceed the volume of typical grinders. In a preferred embodiment, the entire surface of the teeth can grind the material inside the grinding chamber. As the edges of the teeth extend across their entire height, any material in contact with the teeth and any height will meet a grinding surface. The top teeth are long blade-like prongs milled out of an aluminum cylinder while bottom teeth 205B can be created as a manufacturing artifact of milling/drilling out grinding bottom 212.

Since the teeth must be longer to accommodate the grinders narrow and tall shape, there must be a mechanism that prevents the teeth from colliding not only when they are fully engaged with each other but, just as importantly, when the top and bottom halves are first brought together. Other grinders, specifically inexpensive plastic ones, are known to have teeth edges that slowly break off over time. Aside from compromising the integrity of the entire grinder the addition of any foreign ground substance into the material being ground can be harmful to the user: if used as a tobacco grinder the user may inhale dangerous particles, if used to grind food matter the user may ingest particles, etc. To prevent the collision of the teeth, the addition of side walls that are permanently fixed to grinding top 204 and grinding bottom 212. The diameters of the walls are slightly different to allow for the coupling of one side to the other, similar to a sleeve. In addition to acting as the exterior walls of the grinder (keeping in material, etc.), the walls can guide one side of teeth into the other without the possibility of collision. In a preferred embodiment, the top and bottom walls should be of the same height. A net difference in height is not preferred. Such difference may allow space for the teeth to collide with each other. For example, the top wall could technically be only, for example, one-fifth of the height of the bottom teeth. Once the top and bottom are placed together they will be secure and tooth collisions will not occur. However, unless they are placed together very carefully collisions may occur until the point at which the top and bottom are fully secured. The present invention, with walls of equal height, is designed to prevent the top and bottom teeth from coming into contact.

Another aspect of the present invention is the combination of two separate processes into one grinder. First, by way of background, of the several types of grinders some include extra meshed filter chambers—one in a given grinder—at the bottom which are used to collect and save fine particulate for later use. Naturally, such fine particulate chambers must be at the bottom of a grinder so that these lightest and smallest bits of particulate may fall off as the main/larger ground particulate is ground and can be expelled through the top. Second, by way of further background, in the place of these chambers some grinders substitute a funnel at the bottom which expels all ground material downward and out of the grinder. Thus, an aspect of the present invention is to combine both to create an entirely new process in which fine particulate can be gathered at the bottom but the main ground material can still be separate and expelled through a funnel at the top. This way, both processes can happen simultaneously with a single grinder, and the user can have the extra function of the filter and filter chamber while having the convenience and cleanliness of the funneled spout at the top.

### BRIEF DESCRIPTION OF THE DRAWINGS

FIG. 1 (PRIOR ART) shows a typical grinder in contrast to an embodiment of the present invention. Grinders in the related art typically have shorter height and greater diameter, in contrast to taller height and narrower diameter of the grinder of the present invention.

FIG. 2 (PRIOR ART) shows a conventional method of a conventional grinder.

FIG. 3 (PRIOR ART) shows a conventional method of a conventional grinder with inverted funnel at the bottom. The inverted funnel of the related art is an exit structure and does not allow such conventional devices in the prior art to stand like the present invention while collecting fine particulate material, unlike the present invention.

FIG. 4 shows a fully exploded view of an embodiment of the present invention (“Assembly Component View”).

FIG. 5 is a side perspective view of a cap of an embodiment of the present invention.

FIG. 6 is an angled upper perspective view of a funnel top of an embodiment of the present invention.

FIG. 7 is an angled bottom perspective view of a grinding top of an embodiment of the present invention.

FIG. 8 is a bottom perspective view of a grinding top with top magnet in the center of an embodiment of the present invention.

FIG. 9 an angled perspective view of a grinding top wall of an embodiment of the present invention.

FIG. 10 is a view of a grinding bottom with bottom magnet in the center of an embodiment of the present invention.

FIG. 11 is an angled bottom perspective view of a grinding bottom of an embodiment of the present invention.

FIG. 12 is an angled view of the assembled filter top and filter bottom of an embodiment of the present invention. A mesh screen can be a semi-transparent position between filter top and filter bottom.

FIG. 13 is an exploded view of a filter top, a mesh screen, and filter bottom of an embodiment of the present invention.

FIG. 14 is an angled perspective view of a filter chamber of an embodiment of the present invention.

FIG. 15 is an exploded view of an embodiment of the present invention which the user can break down the grinder (“User Component View”).

FIG. 16 is an overall collapsed view of an embodiment of the present invention.

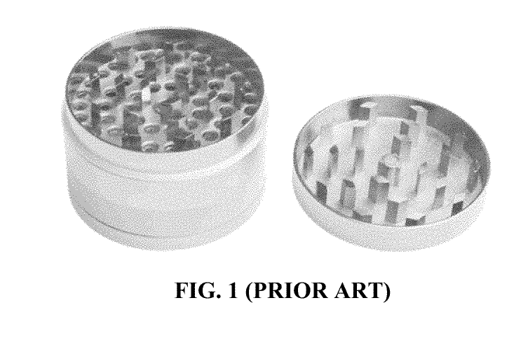

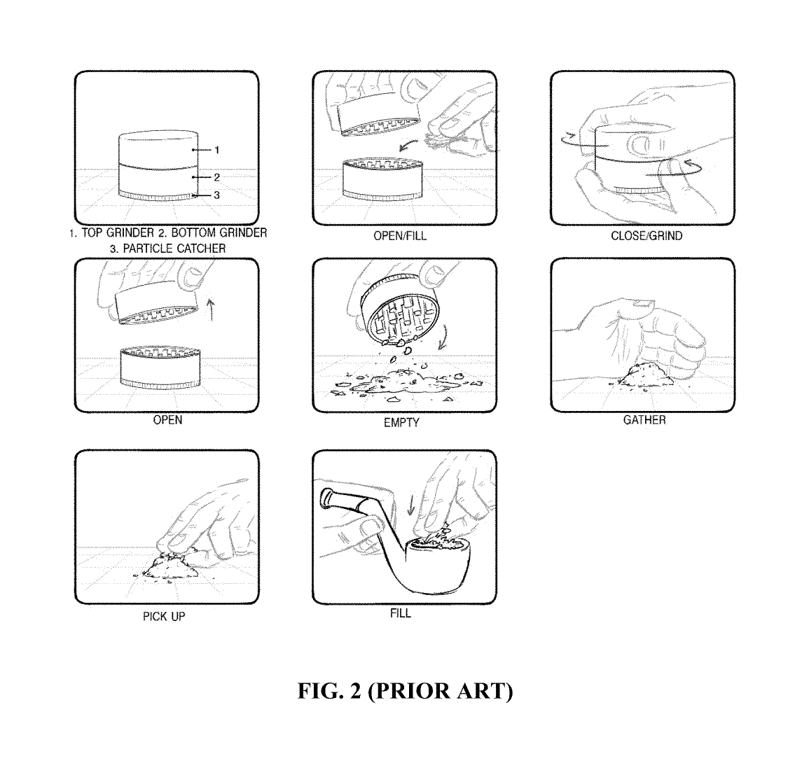

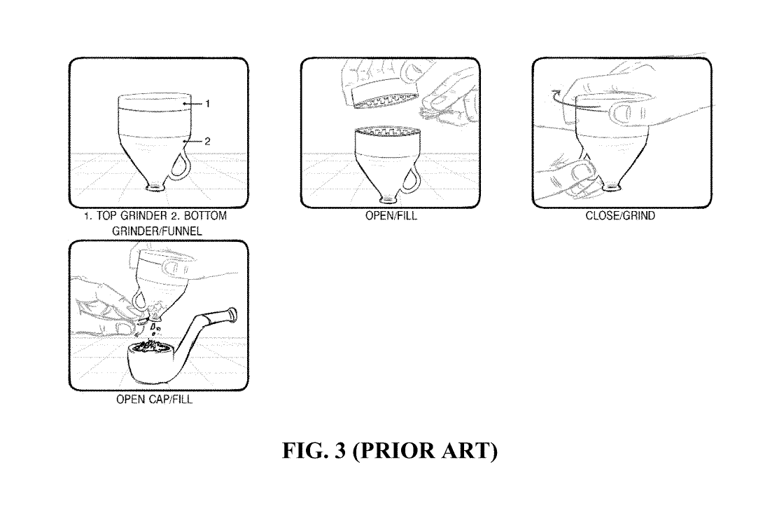

### DETAILED DESCRIPTION OF THE PREFERRED EMBODIMENTS

In the following description of the preferred embodiments, reference is made to the accompanying drawings that form a part hereof: and in which is shown by way of illustration specific embodiments in which the invention may be practiced, it is to be understood that other embodiments may be utilized and structural changes may be made without departing from the scope of the present invention.

References throughout the specification to “a possible embodiment,” “a preferred embodiment,” “some embodiments,” “an embodiment,” and like reference to “embodiment” are non-limiting examples to aid in understanding the present invention. An “embodiment” provides that there can be one or more embodiments that can involve the given element or aspect of the invention. Thus, multiple instances of “an embodiment” and like reference do not necessarily refer to the same embodiment.

This specification provides for specific meanings with respect to the present invention, the meanings of which shall be understood as follows:

With regard to directional top or bottom orientation, the term “top” generally refers to an uppermost direction and is a term of convenience. “Top” is the opposite of “bottom” as used in the disclosure herein. One of ordinary skill would understand that “top” can refer to the upper direction while the present invention is in a resting position with the bottom as shown in FIG. 16. The term “top” is not intended to limit the present invention and has significance when resting the invention. “Top” is also significant as used herein because it differentiates the funnel from conventional funnels which have the funnel for grinding at the bottom. One of ordinary skill in the pertinent art would understand that the present invention would not be inverted and therefore the related art of inverted funnels are old and not novel and not obvious in light of the disclosure of the present invention.

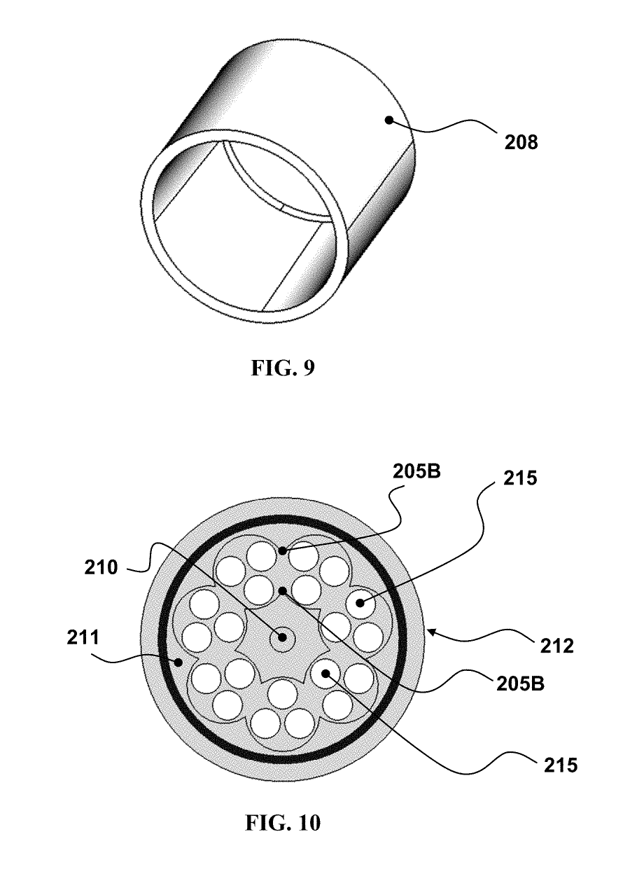

FIG. 4 shows a fully exploded view of an embodiment of the present invention with cap 200, funnel top 202, grinding top 204, top teeth 205, top magnet 206, grinding top wall 208, grinding bottom wall 211, grinding bottom 212, filter top 214, mesh screen 216, filter bottom 218, and filter chamber 220. Top teeth 205 in a preferred embodiment can have an elongated shape, preferably trapezoidal, and preferably in a cylindrical wall such as top wall 208. Bottom teeth 205B (FIGS. 10 & 11) can be an artifact of milling grinding bottom 212, and thus can lay on the edges along both the central and outer walls of the grinding bottom.

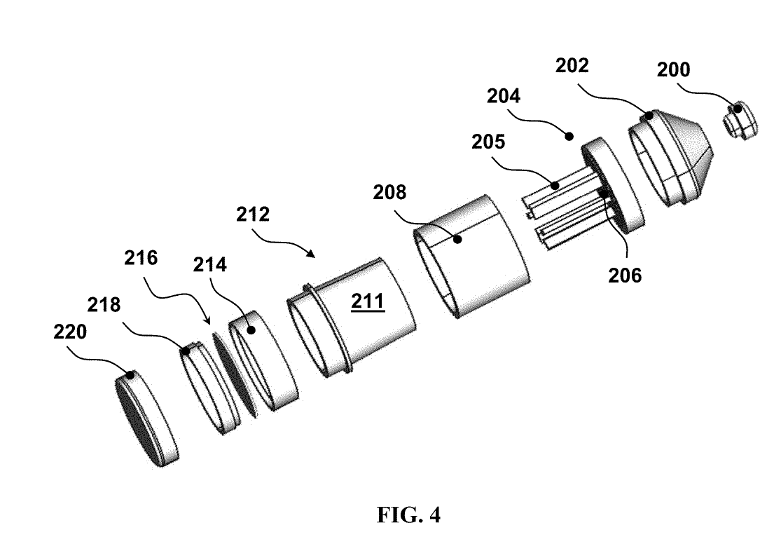

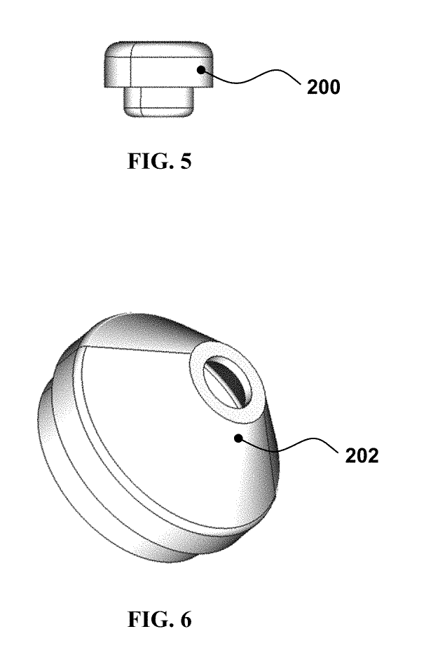

FIG. 5 is a side perspective view of cap 200 of an embodiment of the present invention. In a preferred embodiment, cap 200 can screw on to maintain a tighter seal than in a snap-in cap or lid. Opening cap 200 can allow for pouring. Cap 200 can be attached to the present invention.

FIG. 6 is an angled upper perspective view of funnel top 202 of an embodiment of the present invention. Top 202 acts as a funnel to allow ground matter to fall in a controlled manner into a desired receptacle or surface.

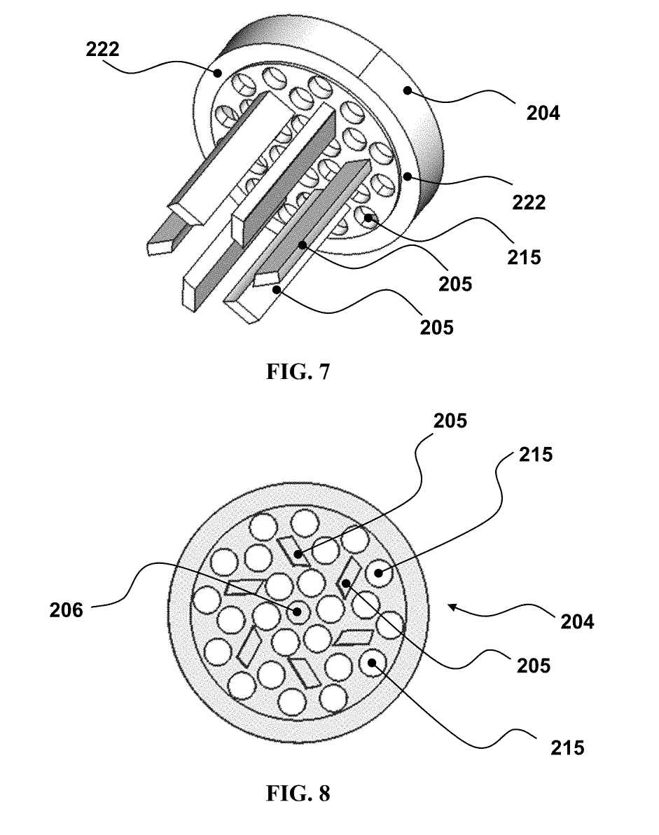

FIG. 7 is an angled bottom perspective view of grinding top 204 of an embodiment of the present invention. Grinding top 204 can be one machined piece. Grinding top 204 can have top teeth 205. A depression can hold top magnet 206, a groove can be inside grinding top 204 in which the top wall 208 can be glued in, and holes 215 which allow ground matter to go from the main grinding chamber out to the top funnel.

FIG. 8 is a bottom perspective view of grinding top 204 with top grinding teeth 205, top magnet 206 in the center of an embodiment of the present invention. A neodymium magnet can be pressed into grinding top 204. Together with bottom magnet 210, top magnet 206 can hold the grinder's major components together.

FIG. 9 is an angled perspective view of grinding top wall 208 of an embodiment of the present invention. A plastic hollow cylinder which can be adhered into grinding top 204. Grinding top wall 208 can fit onto grinding bottom wall 211 to form a main grinding chamber. Thereby, grinding top 204 and grinding bottom 212 can slide together while top grinding teeth 205 and bottom grinding teeth 205B are kept contained and separated.

FIG. 10 shows grinding bottom 212 with bottom teeth 205B, bottom magnet 210 in the center, and holes 215 of an embodiment of the present invention. Bottom magnet 210 can be a neodymium magnet can be pressed into grinding bottom 212, and together with top magnet 206, bottom magnet 210 can facilitate holding together the top grinder and grinding bottom. Bottom teeth 205B can extend from the center of grinding bottom and can also extend from the periphery of grinding bottom 212. In a preferred embodiment, and as shown in FIG. 10, bottom teeth 205B can have inwardly curved portions with sharp edges where said curves meet. One having ordinary skill in the art, based on this disclosure, can appreciate that bottom teeth 205B can be formed by a wide range of curves and/or angles.

FIG. 11 is an angled bottom perspective view of grinding bottom 212 of an embodiment of the present invention. Grinding bottom 212 can provide grinding bottom teeth 205B, inner side wall 211, and there can be a depression for bottom magnet 210. Grinding bottom 212 can be machined out of one piece of aluminum. Grinding bottom 212 can have a bottom side wall, bottom teeth 205B (formed by the machining out of the bottom), a depression for the bottom magnet, and holes 215 which can allow ground matter to go from the main grinding cylinder into the filter area and back.

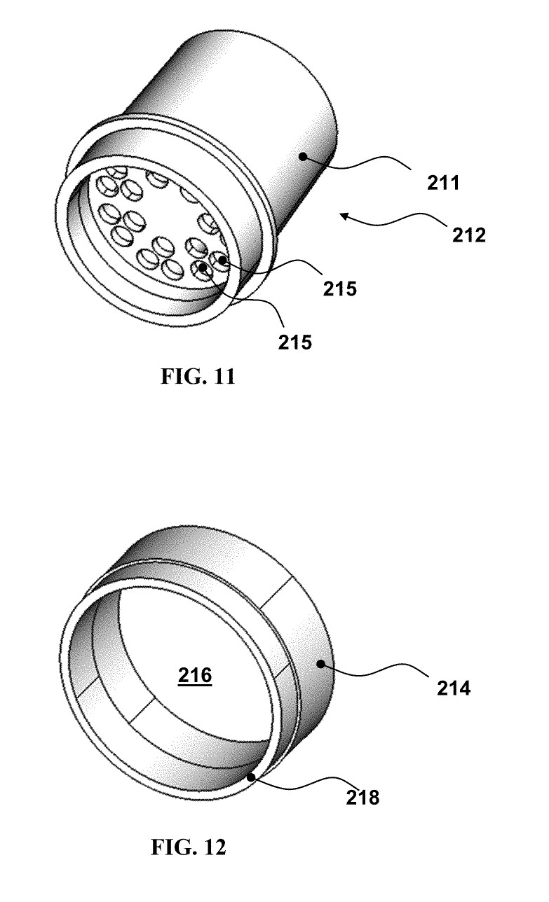

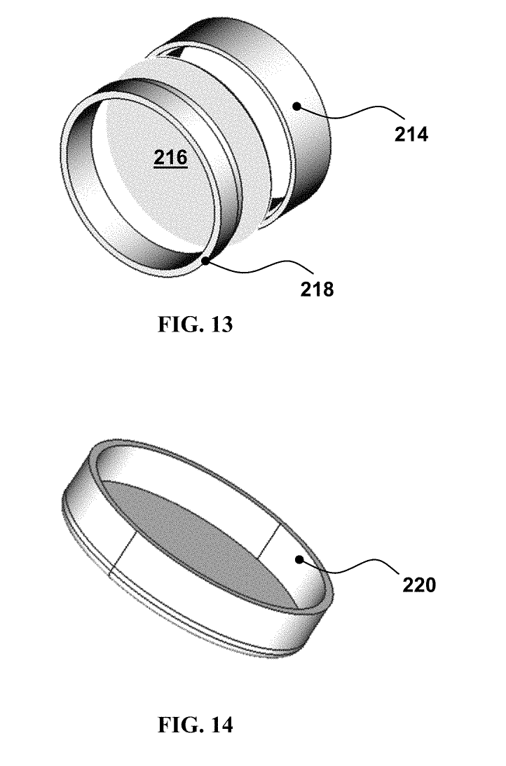

FIG. 12 is an angled view of the assembled filter top 214, and filter bottom 218 of an embodiment of the present invention. Mesh 216 is absent from FIG. 12 but is shown in FIG. 13. Filter top 214 can be a hollowed aluminum cylinder which screws onto the outside of grinding bottom 212. Together with filter bottom 218, filter top 214 can hold mesh 216 in place. Filter 216 can be a mesh screen; can be semi-transparent; and can be positioned between filter top 214 and filter bottom 218.

FIG. 13 is an exploded view of filter top 214, mesh screen 216 and filter bottom 218 of an embodiment of the present invention. Mesh screen 216 preferably can be circular, can be cut out from larger mesh roles. Mesh screen 216 can be held in place when filter top 214 and filter bottom 218 are pressed together. In an embodiment of filtered bottom 218, a hollowed aluminum cylinder can screw onto the inside of the filter chamber 220, which can create a fully enclosed chamber.

FIG. 14 is an angled perspective view of filter chamber 220 of an embodiment of the present invention. Filter chamber 220 can collect finer ground matter after it is passed through mesh screen 216 above it. Filter chamber 220 can be removed separately so that the user can empty out such finer particulate.

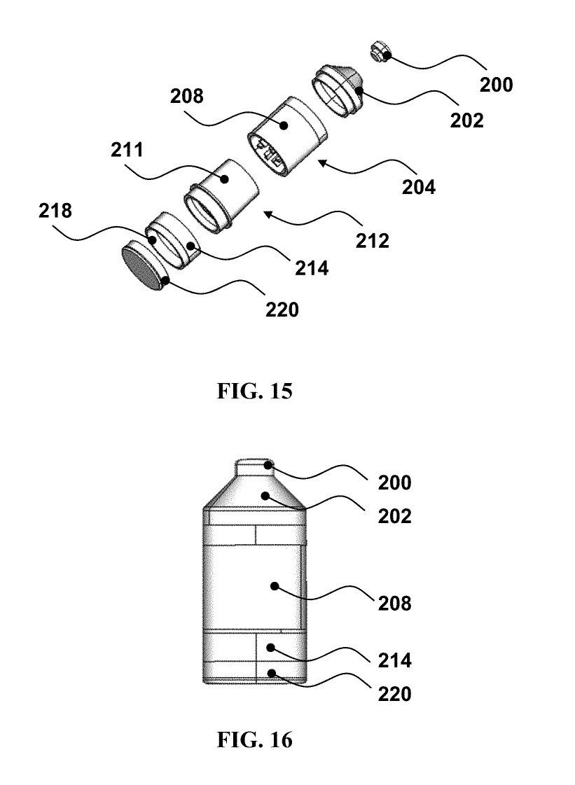

FIG. 15 is an exploded view of an embodiment of the present invention which the user can break down the grinder (“User Exploded View”) with cap 200, funnel top 202, grinding top 204, top teeth 205, top magnet 206, top wall 208, bottom wall 211, grinding bottom 212, filter top 214, mesh screen 216, filter bottom 218, and filter chamber 220. A benefit of the present invention is that the user will typically not need to disassemble the entire device to gain its benefits.

FIG. 16 is an overall collapsed view of an embodiment of the present invention with cap 200, funnel top 202, grinding top 204, grinding top wall 208, grinding bottom 212, filter top 214, filter bottom 218, and filter chamber 220.

Referring to the drawing figures and reference numerals throughout:

In a preferred embodiment, the present invention can be made from twelve parts, one of which can be an adhesive 222. Upon assembly, a user can have 6 parts that easily combine to provide multiple functions. There can be a user-based assembly which has fewer parts. For example, a user can have six pieces: cap 200, funnel 202, top teeth 205 and wall 208, bottom teeth 205B with bottom wall 211, fine particulate mesh 216 with housing 214 and 218 and fine particulate chamber 220.

The following table described each piece by name, material of its composition, raw purchased form, and method of processing. It is listed in a preferred order from top to bottom. The table is followed by a detailed description of each of the pieces and their process of manufacture.

Table 1 is shown below:

| | Preferred | | Preferred | |
|---|---|---|---|---|
| Reference | Component | Preferred | Purchased | Preferred |
| numeral | Structure | Material | Form | Processing |
| 200 | Cap 200 | Plastic | Cylindrical | Machine |
| | (FIGS. 4, 5, | | rods/beads | or cast |
| | 15 & 16) | | | |
| 202 | Funnel 202 | Plastic | Cylindrical | Machine |
| | (FIG. 6) | | rods/beads | or cast |
| 204 | Grinding top | Aluminum | Cylindrical | Machine |
| | 204 (with top | | rods | (lathe |
| | teeth 205 and | | | and mill) |
| | place for top | | | or cast |
| | magnet 206) | | | |
| | (FIGS. 4, 7, | | | |
| | 15 & 16) | | | |
| 206 | Top magnet | Magnet | Purchased | Machine |
| | 206 (FIG. 8) | | as-is | or cast |
| 208 | Grinding top | Plastic | Cylindrical | Machine |
| | wall 208 | | rods/beads | or cast |
| | (FIGS. 4, 9, | | | |
| | 15 & 16) | | | |
| 210 | Bottom magnet | Magnet | Purchased | Purchase as-is, |
| | 210 (FIG. 10) | | as-is | glue in place |
| 212 | Grinding bottom | Aluminum | Cylindrical | Machine (lathe |
| | 212 with | | rods | and mill) |
| | bottom teeth | | | or cast |
| | 205B, inner | | | |
| | side wall 211, | | | |
| | and a depression | | | |
| | for bottom | | | |
| | magnet 210 | | | |
| | (FIGS. 10 & 11) | | | |
| 214 | Filter top 214 | Aluminum | Cylindrical | Machine (lathe) |
| | (FIGS. 12 & 13) | | rods | or cast |
| 216 | Mesh screen | Aluminum, | Rolls | Punch out of |
| | (FIG. 12, 13) | stainless | | rolls |
| | | steel, or | | |
| | | other safe | | |
| | | metal | | |
| 218 | Filter bottom | Aluminum | Cylindrical | Machine (lathe) |
| | (FIGS. 12, 13, 15) | | rods | or cast |
| 220 | Filter chamber | Aluminum | Cylindrical | Machine (lathe) |
| | (FIGS. 4, 14, | | rods | or cast |
| | 15, 16) | | | |
| 222 | Adhesive (FIG. 7) | Glue | Container | Adhere teeth to |
| | | | | walls and |
| | | | | magnets to |
| | | | | grinding top |
| | | | | and/or grinding |
| | | | | bottom |

As Table 1 shows, aluminum is a preferred material which can be widely purchased as rods at a slightly larger diameter than that of the widest component. The pieces can be machined, as the following section will describe, or they can be cast completely after a master is made. In an embodiment, the aluminum parts can also be cast from acrylic, or most other plastics, to create an almost entirely acrylic grinder.

The following is a further non-limiting illustration of a preferred embodiment:

Grinding top 204 can serve multiple purposes, preferably at least five purposes described herein. One side has a threaded cylindrical depression, toward the top of the grinder when the present invention sits upright overall (FIG. 16). Thereby, funnel 202 can be attached, preferably screwed in. The opposite side, toward the bottom of the grinder when it sits flat, can have: grinding teeth; a cylindrical depression in the middle for a magnet; holes to allow for emptying the ground material; and a depressed groove which can run near the outer peripheral circumference where the top side wall can be attached with adhesive 222. The teeth and the sidewall will meet grinding bottom 212's teeth and side wall to create a chamber in which the grinding action takes place.

Grinding top 204 can be lathe turned on the outside to the correct size and dimensions to fit the other components. Then the outside groove is also lathe turned to size. The turned piece will then be cut off from the rest of the rod. The top depression for the funnel 202 is then made by lathe turning the inside of the top, and a threading tool then threads the inside of this depression. The piece is then held by a chuck or special fixture for milling operation. A milling machine then mills the teeth and central magnet depression and drills the holes.

Grinding bottom 212 can be similarly made like grinding top 204 and can serve several purposes. One side can have a cylindrical depression, toward the bottom of the grinder when it sits flat (FIG. 16), where the top part of the filter top and bottom assembly screws in, leading to the lower filter chamber. The opposite side, toward the top of the grinder when it sits flat, can have: grinding teeth; a cylinder in the middle with a depression at the top for a magnet; holes to allow the ground material from the main grinding chamber to fall into the filter chamber; and a bottom side wall which meets the top side wall to form an enclosed chamber.

Grinding bottom 212 can be lathe turned on the outside to the correct size and dimensions to fit grinding top 204. The turned piece will then be cut off from the rest of the rod. A bottom depression for filter top 214 can be made by lathe turning the inside of the bottom of grinding bottom 212, and a threading tool threads the outside of this depression. The piece is then held by a chuck or special fixture for milling operation. A milling machine then mills the teeth, central magnet cylinder, and drills the holes. There can be a cylindrical depression or gap at the top of the magnet cylinder where the magnet can be pressed or glued in with adhesive 222. This depression can be either milled or lathe turned to size.

In a preferred embodiment, the bottom of grinding bottom 212 can have an inner diameter of 1.48 inches. The height of this portion can be 0e.39 inches, followed by a rim which can have an outer diameter of 1.9 inches matching the general outer diameter of the rest of the grinder. The portion above, which holds the teeth 205 of grinding top 204 when the entire grinder is closed, can have a height of 1.47 inches. The outer walls, to accommodate the walls of grinding top 204, can have a slope of 4 degrees. At the top of grinding bottom 212 there can be a depression for bottom magnet 210 to be placed. It can have a depth of 0.1 inches and a diameter of 0.17 inches. When looked from above the channel where the top teeth 205 lay when the grinder is closed can be seen to be made of several overlapping circles. The diameter of each of said overlapping circles can be 0.5 inches.

Filter top 214, together with filter bottom 218, can house mesh filter 216. Filter top 214 can be configured to serve multiple functions in accordance with the present invention. Filter top 214 can screw into the bottom of grinding bottom 212. When combined with filter bottom 218 it can hold mesh filter 216 in place, filter top 214 and bottom 218 can be pressed together with the filter in between them.

In a preferred embodiment, filter top 214 can have an outer diameter of 1.9 inches. The top of filter top 214 can have an inner diameter of 1.7 inches. The bottom of filter top 214 can have an inner diameter of 1.79 inches. Thereby a step can allow filter bottom 218 to fit into. The height of said step can be 0.11 inches. The height of the filter top 214 can be 0.52 inches.

To make filter top 214, it can be drilled on the inside for roughing a pilot hole; and a boring bar can be used to turn the inside to size. A turning tool then lathe can turn the outside and a threading bar can be used to thread the inside of filter top 214, where it screws onto grinding bottom 212. Then the filter top can be cut off.

Mesh 216 can be cut from rolls into a circular shape to fit the diameter in between filter top 214 and filter bottom 218. In a preferred embodiment, mesh 216 can be held in place by filter bottom 218. It serves to filter smaller ground particulate into the filter chamber 220 below the bottom grinder and preferably at the bottom of the overall device as a whole.

Filter bottom 218 can be similar to filter top 214. The inside can be drilled, then brought to size by turning with a boring bar. A turning tool then lathe turns the outside to size and a threading bar can be used to thread the outside of filter bottom 218, where filter bottom 218 can screw into the filter chamber. Filter bottom 218 can then be cut off.

In a preferred embodiment, filter bottom 218 can be configured to serve multiple functions in accordance with the present invention. By way of non-limiting illustration, filter bottom 218 can hold in the filter mesh and to permit the filter chamber to thread onto it. For example, filter bottom 218 can be pressed into the bottom of filter top 214 to hold in the filter mesh. In a preferred embodiment, the outside of filter bottom 218 can be threaded so that the final piece, the filter chamber, can thread onto it.

In a preferred embodiment, filter bottom 218 can have an inner diameter of 1.7 inches. The “step” where filter bottom 218 connects to the filter top 214 can have an outer diameter of 1.78 inches. The height of the “step” can be 0.11 inches.

In a preferred embodiment, filter chamber 220 can be the bottom piece, in order from top to bottom, of the entire grinder. Filter chamber 220 can be screwed onto filter bottom 218 and it can be closed off at the bottom so that it may act as a final collection chamber of small particulate.

In a preferred embodiment, filter chamber 220 can be made in similarly to filter top 214 and filter bottom 218. Filter chamber 220 can be drilled on the inside and brought to size with a boring bar. However, unlike filter top 214 and filter bottom 218 this piece can be not bored all the way through as it can be a closed chamber. A turning tool can then lathe turn the outside to size and a threading bar can be used to thread the inside where the filter chamber can screw onto the filter chamber. It is then cut off.

In a preferred embodiment, filter chamber 220 can have a height of 0.4 inches. A bottom of filter chamber 220 can match the rest of the grinder in diameter and can be 1.9 inches. A floor of filter chamber 220 can be 0.1 inches in height. An inner chamber in filter chamber 220 can have a height of 0.3 inches.

Plastic parts can be purchased as rods to be machined or beads to be injection molded. The following is a description of the acrylic pieces and how they are machined.

In a preferred embodiment, cap 200 can be an acrylic piece. Cap 200 can stop material from falling out of funnel 202. Cap 200 can be lathe turned to size and shape from a smaller diameter rod and cut off. It is threaded on the outside so that it can screw into the hole of funnel 202. In a preferred embodiment, the inner diameter of cap 200 can be between 0.45 and 0.49 inches to match the diameter of the top hole of funnel top 202, preferably 0.47 inches. The outer diameter of cap 200 can be 0.73 inches, the unthreaded top portion of cap 200 can be 0.3 inches in height; and the threaded bottom portion of cap 200 can be 0.2 inches in height.

A benefit of funnel 202, by way of non-limiting illustration, can have dual or multiple purposes. In a preferred embodiment, the top of the funnel can have threads to allow the cap to be screwed in. The related art does not generally have threaded funnels as disclosed by the present invention, let alone a top funnel. Also, in a preferred embodiment, the outer bottom of the funnel 202 can be threaded so that it may screw into the top of grinding top 204. Thereby, top funnel 202 can act as a collection chamber for the main ground material before releasing material by way of opening cap 200. Top funnel 202 can be made by roughing the inside and then, using a boring bar, turned on the inside to the correct size and dimensions. A turning tool then lathe turns the outside and a threading bar can be used to thread the outside of the bottom portion. It can be cut off or have a terminating end.

In a preferred embodiment, the outer diameter of grinding top 204 at the top portion, where the funnel screws in, can be 1.9 inches and the inner diameter 1.7 inches. The height of the inner threaded portion can be 0.3 inches, and the height of the outer portion 0.37 inches. A small step at the outer diameter of the bottom can be where the top wall 208 is adhered or connected; the height of said step can be 0.03 inches. The diameter of the area which is separated by the step can be 1.575 inches. In the center where top magnet 206 lays can be a depression where top magnet 206 is placed, the depth of this depression can be 0.05 inches. The height of the teeth 205 can be 1.47 inches. The inner and outer diameter of the teeth 205, when viewed from below, lay along two diameters, the inner of which can be 0.69 inches and the outer 1.11 inches. The width of the teeth 205 can be 0.1 inches.

Grinding top wall 208 can be attached to a groove in grinding top 204. Grinding top wall 208 can act as the grinder's wall which keeps in the material during grinding. More importantly it, together with the machined-out bottom grinding wall, are essential to the function of the grinder's overall design and are an aspect of the present invention. The teeth of grinding top 204 and bottom are long and narrow and fit into each other when grinding top 204 and bottom 212 are placed within each other. The walls serve to act as guides for grinding top 204 and bottom to prevent the user from mashing and destroying the grinding teeth when the top and bottom are pressed together.

In a preferred embodiment, the outer diameter of grinding top wall 208 can be 1.9 inches. The inner walls can be angled preferably at 4 degrees, widening at the bottom. The top of grinding top wall 208 which adheres to grinding top 204 can be 1.58 inches and the bottom of grinding top wall 208, which is slightly larger due to the ascending angle can be 1.68 inches. The height of the grinding top wall 208 can be 1.53 inches.

Grinding top wall 208 can be made in a similar fashion to most of the other acrylic parts. It can be drilled on the inside to create room for a boring bar to turn the inside to size. A lathe tool then turns the outside to size, and the piece can be cut off.

Magnets can hold grinding top 204 and grinding bottom together, and the adhesive which holds the top wall 208 to grinding top 204. In a preferred embodiment, magnets can be position in depressions each in grinding top 204 and grinding bottom 212. Magnets can be pressed into these depressions where adhesive can also be added for extra hold.

In a preferred embodiment, adhesive 222 and can be used to attach the wall to the groove in grinding top 204. Adhesive can hold top wall 208 to grinding top 204. Adhesive 222 can secure magnets 206 and 210 into their respective depressions.

### Using the Grinder:

The present invention allows use to grind material and capture refined material for use. In a preferred embodiment, the user can easily grind with two parts, while also having six usable pieces for emptying, accessing, and/or and storing material—both unrefined and refined particulate—without being limited to one function as is traditionally known in the related art. By way of non-limiting illustration, from top-down, the user's pieces can include: cap 200, which can open or close to let out unrefined material from the top funnel; funnel 202, which can be screwed onto grinding top 204; grinding top 204 with its sidewall which is held by magnet to grinding bottom 212; grinding bottom 212; the filter housing for filter 216, which can screw onto grinding bottom 212; and filter chamber 220 which can screw onto the filter housing.

To perform the main action of the grinder the user can first separate the top and bottom portions. The top, in this use case scenario, includes funnel 202, grinding top 204, and top wall 208. The bottom can include grinding bottom 212, mesh screen 216 housing (214 & 218), and mesh chamber 220. The user can place material to be ground into the grinding bottom 212 and initiate crushing/grinding action by partially pressing grinding top 204 onto grinding bottom 212. The side walls of grinding top 204 and bottom will ensure that the top and bottom teeth do not come into contact with each other. The user can then grab the grinding top 204 and grinding bottom 212 with one hand to each part and counter-rotate the top and bottom pieces 204 and 212 to finely grind the material inside. Once material is ground to satisfaction the user will turn the grinder upside down (funnel 202 pointing down) and the ground material will enter funnel 202. The user can then unscrew cap 200 and use one hand to hold the grinder and pour the material into a pipe, pan, or any other receptacle held in the other hand, or placed on any surface.

As material is ground and emptied from the top, over time, much finer particulate can be emptied through grinding bottom 212 into the top of mesh filter 216 housing via filter top 214 and filter bottom 218. Mesh 216 can separate the finer material into the bottom filter chamber. Filter housing can be removable from the grinder bottom to scrape or clean out mesh 216. Filter chamber 220 at the bottom can be removed to access or collect the fine particulate which accumulates over time after grinding occurs. Funnel 202 can be removable from grinding top 204 for cleaning from time to time. Each of the foregoing parts can be reattachable.

### CONCLUSION

In summary, the present invention provides an improved, multiuse grinder having inner teeth in a grinding chamber, peripheral walls attached to a grinding top and bottom, a top funnel which can house unrefined material, and a fine particulate capture and storage chamber at the bottom. The foregoing description of the preferred embodiments of the invention has been presented for the purposes of illustration and description. It is not intended to be exhaustive or to limit the invention to the precise form disclosed. Many modifications and variations are possible in light of the above teaching, it is intended that the scope of the invention not be limited by this detailed description, but by the claims and the equivalents to the claims which relate to the present invention.

What is claimed is:

1. An herbal grinding device, comprising:
a grinding top, comprising:
a set of top grinding teeth extend from the grinding top; and
a grinding bottom, comprising:
a set of bottom grinding teeth extend from the grinding bottom.

2. the device of claim 1, further comprising:
a cylindrical wall is formed enclosing the sets of top and bottom grinding teeth with the grinding top and grinding bottom, thereby forming a grinding chamber which permits in-place rotation of the sets of top and bottom teeth via the grinding chamber;

3. the device of claim 2, further comprising:
the cylindrical wall is longer than it is wide and thereby capable of accommodating the sets of top and bottom grinding teeth therein thereby elongating the grinding chamber.

4. the device of claim 3, further comprising:
the top and bottom grinders are rotatable without colliding with their respective teeth.

5. the device of claim 4, further comprising:
the grinding bottom forms an at least one tooth of the bottom teeth.

6. the device of claim 5, further comprising:
wherein the top and bottom walls guide the grinding top and grinding bottom together during rotation such that the set of top teeth do not come into contact with the set of bottom teeth.

7. the device of claim 6, further comprising:
a filter comprising holes in the grinding top.

8. the device of claim 7, further comprising:
an at least one tooth, selected from either the set of bottom teeth or the set of top teeth, is longer than the width of the at least one tooth.

9. the device of claim 8, further comprising:
the at least one tooth, selected from either the set of bottom teeth or the set of top teeth, is trapezoidal.

10. the device of claim 9, further comprising:
the at least one tooth, selected from either the set of bottom teeth or the set of top teeth, is prong-like.

11. the device of claim 9, further comprising:
the at least one tooth, selected from either the set of bottom teeth or the set of top teeth, is blade-like.

12. the device of claim 9, further comprising:
the cylindrical wall (“top wall”) forms a diameter slightly different from a bottom wall which is also cylindrical, thereby coupling said top and bottom walls in a sleeve-like manner.

13. the device of claim 12, further comprising:
the bottom grinder comprises a series of holes.

14. the device of claim 13, further comprising:
a fine particulate mesh is positioned below the bottom grinder and is thereby capable of filtering finely ground herbal material before reaching a fine particulate chamber.

15. the device of claim 14, further comprising:
wherein the fine particulate chamber is below the grinding bottom opposite the side of the set of bottom grinding teeth.

16. the device of claim 15, further comprising:
a depression holds a top magnet inside the grinding top made of metal; and grinding bottom is made of metal.

17. the device of claim 16, further comprising:
a funnel top is removably attachable to the grinding top having a circumference to fit the outer diameter of the funnel top.

18. the device of claim 17, wherein the cylindrical wall is adhered to the grinding top opposite the funnel top.

19. the device of claim 18, further comprising:
the set of bottom teeth is longer than wide; and
the set of top teeth is longer than wide.

20. An herbal grinding device, comprising:
an herbal grinder having a set of top teeth and a set of bottom teeth in a grinding chamber;
an at least one tooth of the set of top teeth is longer than wide;
an at least one tooth of the set of bottom teeth is longer than wide;
a first peripheral cylindrical wall attached to a grinding top in the grinder;
a second peripheral cylindrical wall attached to a grinding bottom in the grinder;
the first and second peripheral walls have different complementary diameters and are capable of being coupled in a sleeve-like manner such that the set of top teeth avoids contact with the set of bottom teeth;
a top funnel to house unrefined material is removably attachable to the grinding top via a threaded edge; and
a fine particulate chamber is removably attachable to the bottom grinder and capable of capture and storage of finely ground material.
